(19) United States
(12) Patent Application Publication
(10) Pub. No.: US 2013/0235260 A1
(43) Pub. Date: Sep. 12, 2013

(54) A Button with Lens for a Display Housing

(71) Applicants: Rahul Lakdawala, Cypress, TX (US); Earl Moore, Cypress, TX (US); Mark Ruch, The woodlands, TX (US)

(72) Inventors: Rahul Lakdawala, Cypress, TX (US); Earl Moore, Cypress, TX (US); Mark Ruch, The woodlands, TX (US)

(21) Appl. No.: 13/883,838

(22) PCT Filed: Jan. 14, 2011
(86) PCT No.: PCT/US11/21317

§ 371 Date: May 7, 2013

(51) Int. Cl. G01D 11/28; H04N 5/225

(52) U.S. Cl. CPC G01D 11/28; H04N 5/2252
USPC 348/373; 362/23.19; 362/23.02

(57) ABSTRACT

An electronic device display comprising an outer housing to surround a display screen, a button disposed on the outer housing, and a lens disposed on the button to allow light to enter the interior of the outer housing.

### BACKGROUND

An electronic device such as a notebook computer may include a keyboard and a display screen. The device may include various components such as an ambient light sensor for adjusting the backlight of the display screen based on ambient light conditions. The device may also include a camera to allow a user to capture images and/or video of themselves. The device may also include a light source to illuminate the keyboard of the computer. Such components consume space on the device.

### BRIEF DESCRIPTION OF THE DRAWINGS

For a detailed description of example embodiments, reference will now be made to the accompanying drawings in which:

FIG. 1 is a perspective view of an embodiment of a computer having a button with a lens as part of the outer housing of the display;

FIG. 2A is a detailed perspective view of the upper portion of the outer housing of the computer of FIG. 1 in accordance with at least some illustrative embodiments;

FIG. 2B is a partial side view of the outer housing showing a button in an actuated state in at least some illustrative embodiments;

FIG. 2C is a partial side view of the outer housing showing an illuminator in an activated state in accordance with at least some illustrative embodiments;

FIG. 3A is a detailed perspective view of the upper portion of the outer housing of the computer of FIG. 1 in accordance with at least some illustrative embodiments;

FIG. 3B is a partial side view of the outer housing showing the button in a deactuated state in at least some illustrative embodiments;

FIG. 3C is a partial side view of the outer housing showing an illuminator in an deactivated state in accordance with at least some illustrative embodiments; and

FIG. 4 is a block diagram in an embodiment of architecture of the computer of FIG. 1.

### DETAILED DESCRIPTION

Disclosed is an embodiment of an electronic device such as a notebook computer having a display screen with an outer housing surrounding the display screen. A button is disposed on the outer housing and a lens is disposed on the button to allow ambient light to enter the interior of the outer housing. In some embodiments, the ambient light can be used by a light sensor to adjust a backlight of the display screen. In other embodiments, the button can be used to activate an illuminator such as a light source to illuminate a working surface of the computer such as the keyboard portion of the computer. In other embodiments, a graphic symbol, such as an icon, representing a feature of the computer, such as the illuminator, may be disposed on a surface of the button. In this manner, the lens being integrated with the button may help reduce the amount of space consumed on the housing which may decrease the cost of manufacturing of the computer. In addition, the reduction of space may help improve the aesthetic look of the computer.

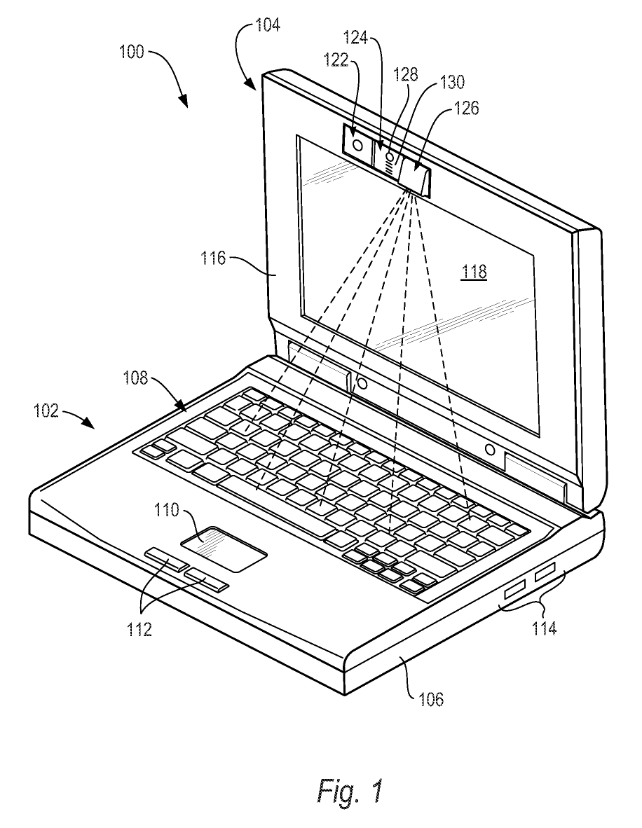

Various embodiments and the advantages thereof are best understood by referring to FIGS. 1, 2A-2C, 3A-3C and 4 in which like numerals are being used for like and corresponding parts of the various drawings.

Referring now in more detail to the drawings, in which like numerals indicate corresponding parts throughout the views, FIG. 1 illustrates an electronic device 100 in the form of a notebook or “laptop” computer. It should be understood that the electronic device can be any type of computing device such as, but not limited to, a tablet personal computer, a personal digital assistant, a smart phone, a desktop computer, a gaming device or any type of portable or non-portable electronic device. As indicated in FIG. 1, the electronic device 100 includes a base 102 and a display 104 that is pivotally connected to the base. The base 102 includes an outer housing 106 that surrounds various internal components of electronic device 100, such as a processor, memory, hard drive, and the like. Also included in base 102 are user input devices disposed on a working surface of the base, including a keyboard 108, a touchpad 110, selection buttons 112 and input/output ports 114. The display 104 includes its own outer housing 116 that supports and surrounds a display screen 118, such as a liquid crystal display (LCD) screen.

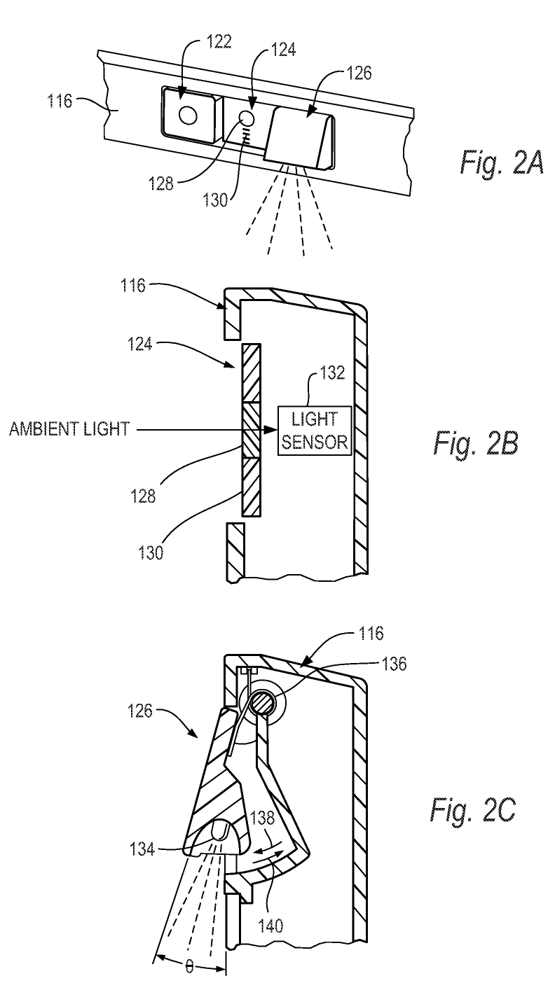

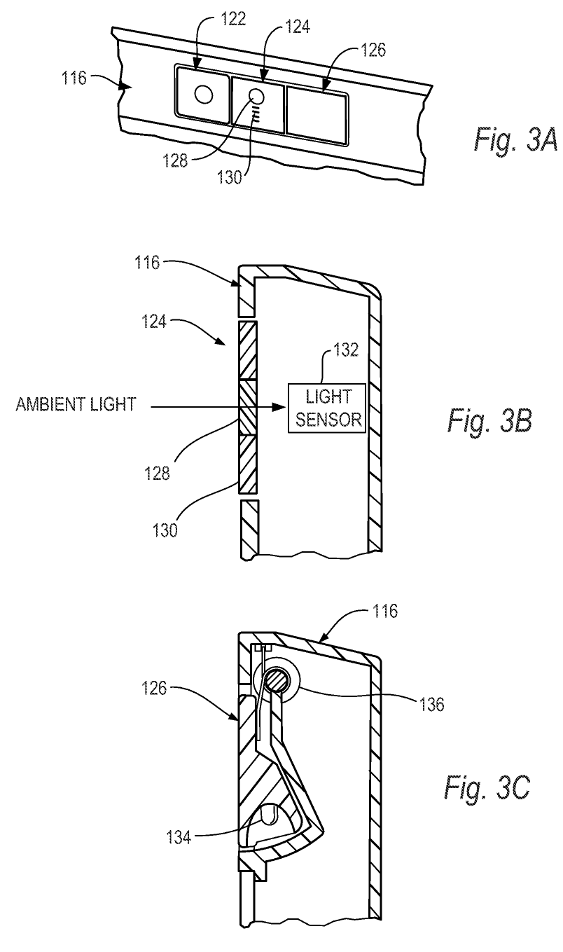

Integrated into outer housing 116 is a “web” camera 122, a button 124, and an illuminator 126. The camera 122, button 124, and illuminator 126 can be positioned adjacent each other along a top side or edge of outer housing 116. However, it should be understood that such components can positioned along other portions of outer housing or other portions of the device 100. The camera 122 can be used when capturing still images and/or video data of a subject, such as the computer user. As explained below in further detail, a lens 128 is disposed on button 124 to allow ambient light to enter the interior of outer housing 116 and be received by an ambient light sensor disposed within the interior of the outer housing. A graphic symbol 130, such as an icon, representing the illuminator 126 is disposed on an outer surface of button 124. The button 124 can be actuated, such as pressed, to activate or enable illuminator 126. For example, button 126 can cause illuminator 126 to extend outward away from outer housing 116 to illuminate light onto a surface of base 102 such as keyboard 108, as shown in FIG. 1 and FIGS. 2A-2C. The button 124 can also be pressed to deactivate illuminator 126. For example, button 124 can cause illuminator 126 to retract inward toward outer housing 116 and to disable the illuminator to no longer illuminate light as shown in FIGS. 3A-3C. In this manner, having lens 128 integrated with button 124 may help reduce the amount of space consumed on outer housing 116 which may help improve the aesthetic look of the device. Although camera 122, button 124 and illuminator 126 are shown disposed on the upper portion of outer housing 116, it should be understood that these components can be disposed on other portions of outer housing such as the left, right, and lower portions of the outer housing. Although camera 122 is shown integrated with electronic device 100, it should be understood that electronic device can be embodied without camera 122. Although camera 122 is shown integrated with electronic device 100, it should be understood that another module, such as a microphone, speaker and the like, can be employed instead of camera 122.

FIGS. 2A-2C illustrate a detailed perspective view of the upper portion of outer housing 116 with button 124 in the actuated state and illuminator 126 in the activated state.

Referring to FIGS. 2A and 2B, lens 128 is shown integrated within the structure of button 124. However, it should be understood that lens 128 can configured in other arrangements such as disposed on the interior or exterior surface of button, combined with protective layers to reduce damage to the lens and the like. The button 124 can be implemented using any actuating mechanism such as a push mechanism, slide mechanism or the like. The button 126 can include hardware components, software components or a combination thereof. The button 126 may include functionality to cause an electrical switch to enable (turn on) and disable (turn off) illuminator 126. The graphic symbol 130 is shown as a “light bulb” icon representing the function of illuminator 126 and disposed on an outer surface of the button. The round portion of the “light bulb” icon occupies the location of lens 128 which may help reduce the amount of physical space consumed on outer housing 116. However, it should be understood that graphic symbol 130 can be take any form and represent any feature of electronic device 100. The graphic symbol 130 may be placed on the surface of button 124 using any technique such as printing, laser etching and the like. The lens 128 may allow ambient light to enter the interior of outer housing 116 and be received by ambient light sensor 132 which is disposed within the interior of the outer housing. The ambient light sensor 132 can be configured to receive the ambient light around display screen 118 and automatically adjust the screen's backlight to an optimized brightness level. The ambient light sensor 132 can be any device capable of detecting available environmental light and automatically increasing or decreasing the display backlighting to compensate for low-light and high-light environments. For example, ambient light sensor 132 may be able to reduce the display screen's brightness when it is used in a dark room. On the other hand, ambient light sensor 132 may be able to increase the brightness of the display screen when it is in a well-lit environment. In this manner, the user may be provided a consistent image quality as well as minimization of eye strain and reduction of power consumption.

Referring to FIGS. 2A and 2C, illuminator 126 comprises a light assembly with a housing to support a light source 134. In one embodiment, the light assembly is pivotably coupled and securable within outer housing 116 of display 104 by a locking mechanism. The light assembly is disposed at a medial location above display screen 118. However, it should be understood that light assembly may be otherwise located (e.g., at any other position on outer housing). It should also be understood that light assembly may also be pivotably coupled to base 102.

The illuminator 126 is shown in an extended position when in the activated state. When in the extended orientation, the housing of illuminator 126 extends outwardly from display screen 118 to expose light source 134 to illuminate working surface of base 102 such as a portion of keyboard 108. In the embodiment shown, light source 134 comprises at least one light emitting diode disposed within the housing of the illuminator. However, it should be understood that other types of light sources including, but not limited to, light bulbs, black light sources, etc., may be used.

The housing of illuminator 126 is pivotably coupled to outer housing 116 to facilitate movement of the illuminator in the direction of arrows 138 and 140. According to some embodiments, the illuminator is outwardly biased by a biasing mechanism 136 to expose light source 134 and enable illumination of the working surface of base 104. The biasing mechanism 136 is shown as torsion spring, however, it should be understood that biasing mechanism may be any type of biasing mechanism to outwardly bias illuminator 126, and thus light source 134, from outer housing 16.

The illuminator is positionable in the extended position such that light source 134 is disposed at an angle θ relative to display screen 118 to direct light in a plurality of different angular extended positions relative to display screen 118 and/or working surface of base 104 to direct light to desired portions of the working surface. In other embodiments, illuminator 126 may be configured to be located in two positions, namely, a fully extended position and a retracted or stored position.

In operation, a user may actuate button 124 to cause illuminator 126 to move into the extended position. For example, actuation of button 124 may include having a user press the button inward toward the interior of outer housing 116 to which caused the button to move into the retracted position. Such actuation may cause the biasing mechanism to release illuminator 126 from the retracted position to the extended position to expose light source 134 and enable illumination of the working surface of base 104. Independent of the actuation of button 124 or the position of illuminator 126, the button allows ambient light to continue to enter through lens 128 and be received by ambient light sensor 132 for subsequent processing. For example, the ambient light conditions can be used to adjust the backlighting of display screen 118.

FIGS. 3A-3C illustrate a detailed perspective view of the upper portion of outer housing 116 with button 124 in the deactuated state and illuminator 126 in the deactivated state (retracted position). In the retracted position, the housing of illuminator 126 is locatable within a recessed area of the interior of outer housing 116. When illuminator 126 is configured in the retracted or stored position, a front surface of the housing of illuminator is flush (flush or substantially flush) with a forwardly facing surface of outer housing 116. However, it should be understood that in some embodiments, the housing of illuminator 126 may extend slightly outwardly from outer housing 116 such that the housing of illuminator 126 is at least partially disposed within other housing 116 in a retracted position.

In operation, a user may deactuate button 124 to cause illuminator 126 to move into the retracted position. For example, deactuation of the button may include having a user press the button while the button is in the retracted position which will cause the button to extend outward away from the outer housing and be flush with the surface of the outer housing. Such deactuation may cause the biasing mechanism of illuminator 126 to retract illuminator from the extended position to the retracted position and to turn off (disable) light source 134 and sable illumination of the working surface of base 104. In a similar manner as when the illuminator is in the extended position, independent of the position of button 124 or position of illuminator 126, button 124 allows ambient light to continue to enter through lens 128 and be received by ambient light sensor 132 for subsequent processing. For example, the ambient light conditions can be used to adjust the backlighting of display screen 118.

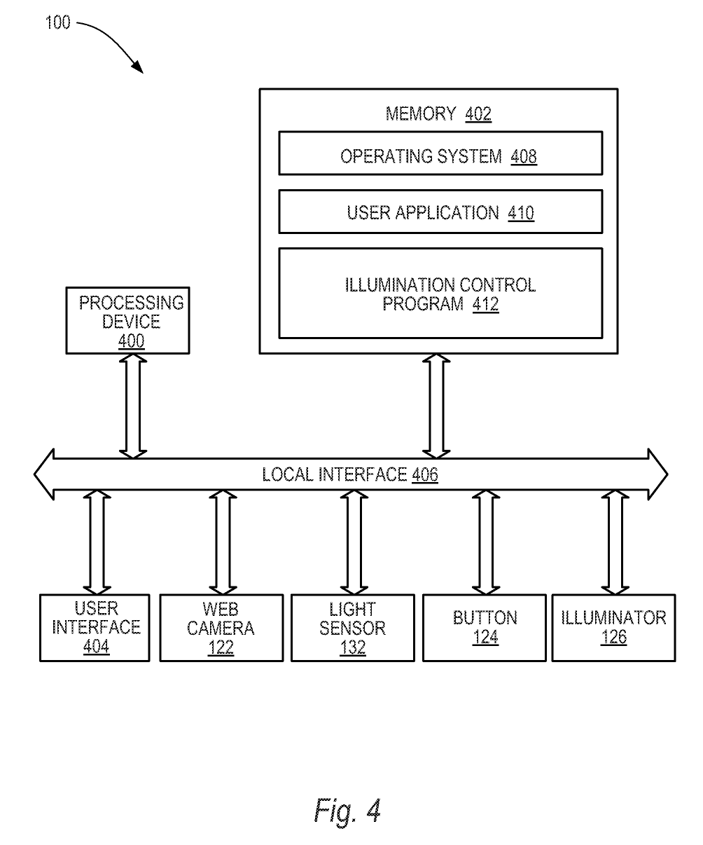

FIG. 4 illustrates a block diagram of architecture for electronic device 100 in accordance with at least one embodiment. As indicated in FIG. 4, computing device 100 comprises a processing device 400, memory 402, a user interface 404, web camera 122, light sensor 132, button 124 and illuminator 126, each of which is connected to a local interface 406. The local interface 406 can include any interface means, such as for example, buses like universal serial bus (USB), system management bus (SMBUS), peripheral component interconnect express (PCIE) the like, to interface with devices such as the camera, sensor and the like.

The processing device 400 can comprise a central processing unit (CPU) that controls overall operation of electronic device 100 and memory 402 may include anyone of or a combination of volatile memory elements (e.g., RAM) and nonvolatile memory elements (e.g., hard disk, ROM, tape, etc.) that store code that can be executed by processing device 400.

The user interface 404 comprises the components with which a user interacts with electronic device 100, such as keyboard 108, touchpad 110, buttons 112 and input/output ports identified above in relation to FIG. 1. The web camera 122 may comprise an image sensor that converts an optical image to an electric signal. By way of example, the image sensor may comprise a charged-coupled device (CCD) or a complementary metal-oxide-semiconductor (CMOS) sensor. The light sensor 132 may comprise a photodetector, such as a photodiode, that converts light intensity into an electric signal. An embodiment for illuminator 126 has been described above. The illuminator 126 may further include a control element that receives instructions from the processing device 400 that indicated how to control the light.

The memory 402 may comprise various programs (i.e., logic), including an operating system 408 one or more user applications 410, and an illumination control program 412. The operating system 408 may control the execution of other programs and provides scheduling, input-output control, file and data management, memory management, and communication control and related services. The user applications 410 can comprise any application that executes on electronic device 100, which may include an image capture program, a video conferencing program, and the like.

The illumination control program 412 may include instructions which when executed by processing device 400 may control the operation of camera 122, button 124 and illuminator 126. The control program 412 may be able to control the operation of web camera 122 by capturing one or more images, or preparation for capturing one or more images. The control program 412 may control the interaction of button 124 and illuminator 126. For example, control program 412 can be configured to detect actuation of button 124 and cause activation of illuminator 126. The control program 412 may also be configured to control ambient light received by light sensor 132. For example, control program 412 may detect ambient light received by light sensor 132 and use such ambient light conditions to control the backlighting of display device 118.

The software in memory may include one or more separate programs, each of which comprises an ordered listing of executable instructions for implementing functions. The software in the memory may include software to implement control program 412. The control program 412 can include source program, executable program (object code), script, or any other entity comprising a set of instructions to be performed. When it is a source program, then the program needs to be translated via a compiler, assembler, interpreter, or the like, which may or may not be included within the memory, so as operate properly in connection with the O/S. Furthermore, control program 412 can be written as (a) an object oriented programming language, which has classes of data and methods, or (b) a procedure programming language, which has routines, subroutines, and/or functions, for example but not limited to, C, C++ and Java. In some embodiments, the software in memory may further include a basic input output system (BIOS). The BIOS can include a set of essential software routines that initialize and test hardware at startup, start the O/S, and support the transfer of data among the hardware devices. The BIOS can be stored in memory (ROM) so that the BIOS can be executed when electronic device 100 is activated.

When electronic device 100 is in operation, processing device 400 can be configured to execute software stored within the memory, to communicate data to and from the memory, and to generally control operations of electronic device 100 pursuant to the software. The control program 412 and other programs, in whole or in part, but typically the latter, can be read by the processing device, perhaps buffered within the processor, and then executed.

When control program 412 is implemented in software, the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The control program 412 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic device display comprising:
outer housing to surround a display screen;
a button disposed on the outer housing; and
a lens disposed on the button to allow light to enter the interior of the outer housing.

2. The electronic device display of claim 1, further comprising an illuminator that is integrated into the outer housing.

3. The electronic device display of claim 2, wherein the button is configured to activate the illuminator.

4. The electronic device display of claim 2, further comprising a graphic symbol representing the illuminator disposed on a surface of the button.

5. The electronic device display of claim 1, further comprising a light sensor disposed within the outer housing.

6. The electronic device display of claim 5, wherein the light sensor is configured to adjust brightness of backlight of a display screen based on ambient light sensed by the light sensor received through the lens.

7. The electronic device display of claim 1, further comprising a camera that is integrated into the outer housing.

8. The electronic device display of claim 1, further comprising a display screen that is surrounded by the outer housing.

9. The electronic device display of claim 1, wherein the display comprises part of a notebook computer.

10. An electronic device comprising:
a base; and
a display that is connected to the base, the display comprising a display screen that is surrounded by an outer housing, a button disposed on the outer housing, a light sensor disposed within the outer housing, and a lens disposed on the button to allow ambient light to be received by the light sensor.

11. The electronic device of claim 10, further comprising an illuminator that is integrated into the outer housing and configured to be activated by actuation of the button.

12. The electronic device of claim 11, further comprising a graphic symbol representing the illuminator disposed on an outer surface of the button.

13. The electronic device of claim 11, wherein the illuminator when activated is configured to illuminate at least a portion of the base.

14. The electronic device of claim 10, wherein the light sensor is configured to adjust brightness of backlight of the display screen based on the ambient light received by the light sensor.

15. The electronic device of claim 10, further comprising a camera that is integrated into the outer housing.
